(19) United States
(12) Patent Application Publication
(10) Pub. No.: US 2010/0250911 A1
(43) Pub. Date: Sep. 30, 2010

(54) SENSOR FOR USE IN AUTOMATION TECHNOLOGY AND METHOD FOR CONFIGURING A SENSOR

(75) Inventors: Dennis Trebbels, Neustadt an der Weinstrasse (DE); Heiko Hoebel, Worms (DE); Tobias Bergtholdt, Mannheim (DE)

Correspondence Address: HOFFMAN WARNICK LLC, 75 STATE STREET, 14TH FLOOR, ALBANY, NY, 12207, US

(73) Assignee: PEPPERL + FUCHS GMBH, Mannheim (DE)

(21) Appl. No.: 12/744,080

(22) PCT Filed: Nov. 20, 2008
(86) PCT No.: PCT/EP08/09845

§ 371 Date: May 21, 2010

(30) Foreign Application Priority Data
Nov. 21, 2007 (EP) 07022630.3

(51) Int. Cl. G06F 9/24; G06F 1/26; G06F 3/00; G06F 19/00

(52) U.S. Cl. 713/2; 713/300; 710/17; 710/8; 702/108

(57) ABSTRACT

The present invention is directed to a sensor for use in automation technology for detecting a measurand, particularly for detecting objects or articles, and a method for configuring a sensor. The sensor includes: a sensor element for measuring a physical variable; a first connecting means for connecting the sensor to a peripheral unit in an operating mode; and a control/evaluation unit for controlling the sensor element, for processing a measured signal from the sensor element and for outputting an output signal to the first connecting means, which control/evaluation unit has a memory for the storage of at least configuration data and program data of the sensor; wherein a second connecting means connects the sensor to an external computer for a configuring mode; in the memory of the control/evaluation unit there is stored configuring software, which can be uploaded into a RAM of an external computer when the sensor is connected to the external computer; and the configuring software is adapted for automatic configuration of the sensor or interactive configuration thereof by a user.

The present invention relates, in a first aspect, to a sensor for use in automation technology for detecting a measurand, particularly for detecting objects or articles, as defined in the generic clause of claim 1.

In a second aspect, the invention relates to a method for configuring a sensor for use in automation technology.

A generic sensor comprises a sensor element for measuring a physical variable, and a first connecting means for connecting the sensor to a peripheral unit. Furthermore, a control/evaluation unit is present for controlling the sensor element, for processing a measured signal from the sensor element and for outputting an output signal to the first connecting means, the control/evaluation unit comprising a memory for storing at least configuration data and program data for the sensor.

Such sensors are known in numerous forms, for example, as inductive, capacitive or optical sensors and as temperature sensors, pressure sensors, fluid-level sensors and also position sensors or rotation sensors.

Special programming devices have been used hitherto for programming and/or configuring such sensors. Usually, RS232 or RS485 interfaces are used. But the data transfer rate is comparatively low in such cases so that an update of relatively large software volumes is cumbersome. In an alternative method, the necessary data are transferred to the sensor with the aid of intermittent short-circuiting. For this purpose, the sensor is usually disconnected from the peripheral unit to which it is connected in the normal measuring mode, and the programming device is connected to the vacant plug-type connector. The required configuration data, in particular the latest firmware, is then transferred to the sensor by means of defined short-circuits between the individual contacts of the plug-type connector. A separate programming device is likewise required for this purpose, and this procedure is likewise relatively slow.

A proximity switch, in which both data and electrical energy are transferred by means of an electrical connection, is described in DE 41 23 828 C2. U.S. 2005/0083741 A1 and U.S. Pat. No. 7,165,109 B2 relate to the functionality of USB components. U.S. Pat. No. 7,165,109 B2 describes a process by means of which a component connected to a USB interface of a computer prompts this computer to download a suitable driver for the component via the Internet. Sensors or field devices that can be configured and/or observed by means of an external computer are described in U.S. 2003/0120714 and U.S. Pat. No. 6,978,294.

It is an object of the invention to provide a sensor which can be configured more easily than sensors known in the prior art. A further object is to provide a method which facilitates the configuration of sensors.

This object is achieved, in a first aspect of the invention, by means of the sensor having the features defined in claim 1.

In a second aspect of the invention, the object is achieved by means of the method having the features defined in claim 11.

Preferred embodiments of the sensor of the invention and advantageous variants of the method of the invention are the subject matter of the dependent claims and are further explained in the following description, particularly with reference to the figure.

The sensor of the aforementioned type is developed by the invention in that a second connecting means is present for connecting the sensor to an external computer for use in a configuring mode, a configuring software program being stored in the memory of the control/evaluation unit, which configuring software program can be uploaded into the RAM of an external computer when the sensor is connected to the external computer, and the configuring software program is adapted to effect automatic configuration or to allow interactive configuration of the sensor by a user.

In the method of the invention for configuring a sensor, the sensor is temporarily connected to an external computer. A configuring software program stored in the memory of the sensor is then uploaded into a RAM of the computer, and the sensor is then configured automatically, or by a user, with the aid of the configuring software program.

A first central idea underlying the invention may be considered to be the realization that microcontrollers and memory modules presently available have a sufficiently large memory capacity for the storage of configuration or parameterization software program for the sensor.

A further basic idea underlying the invention may be considered to be the concept of designing the sensor so as to be autarkic in that the software program required for configuring the sensor is contained in the sensor itself.

An essential advantage of the invention is that additional programming devices such as protocol converters, interface converters or programming devices for intermittent short-circuiting are no longer necessary. Furthermore, CDs, DVDs or similar data media containing the necessary parameterization or configuration data need not be included with the sensor. Finally, the method of the invention makes it unnecessary for the user to install software on the external computer. Moreover, it is advantageous that conventional hardware and platform-independent software can be employed for carrying out the method of the invention.

The sensor element can basically be any element suitable for detecting a physical variable. For example, the sensor element can be a coil or an oscillator circuit of an inductive proximity switch, a photodetector of an optical sensor, a capacitive probe, or a thermocouple.

Accordingly, the sensors can be basically any kind of sensors for detecting a measurand or for detecting objects or articles. It is particularly advantageous to apply the present invention to sensors used in the industrial sector, for example, inductive, capacitive or optical sensors, temperature sensors, or pressure sensors. For example, they can be identification sensors such as RFID reading heads.

The term “configuration” should, for the purposes of the present description, be taken to mean any alteration or adjustment of the sensor as effected by a software program. This comprises, in particular, any transfer of program code or binary code to the sensor and uploading of firmware and modification of, and/or the addition of, parameters.

Basically, the peripheral unit can be a relay, other switchgear or control equipment, a power supply or an analyzing unit or a bus system. In most instances, the sensor will be connected, in the operating mode, to a programmable logic control unit as the peripheral unit.

For the purposes of the present description, the term “control/evaluation unit” is to be understood to mean essentially any intelligent electronic components of the sensor. In principle, the control/evaluation unit can be composed of a plurality of microcontrollers, FPGAs, CPLDs, GALs, or other programmable logic components, and optionally assigned memory modules by means of which different functionalities can be implemented, for example.

The term “connecting means” is, for the purposes of the present description, to be understood to mean those components that are necessary in order to establish an interfaced connection, that is, a data transfer link, between the sensor and the external computer or between the sensor and a peripheral unit. This interfaced connection is preferably also adapted to transfer electrical energy. All this can theoretically be carried out wirelessly, for example by radio transmission, if desired. In advantageous embodiments of the sensor of the invention, however, plug-type connectors, by means of which both data and, optionally, electrical energy can be transferred, are used as connecting means. One particular advantage of the invention is that virtually any type of computer can be used as the external computer. For example, PCs can be used in the manufacturing process, and, in particular, customized parameter settings and tests on function can be carried out. Should reconfiguration or calibration be necessary at the site of action, it is preferred to use laptops, handhelds, or palmtops. Theoretically, a cellular phone could be used for this purpose.

In the configuring mode, the sensor is connected to the external computer and the configuring software program stored in the sensor is started on the external computer as proposed by the invention.

It is theoretically possible to provide the sensor with an independent voltage supply in the form of, for example, an independent power supply unit, a battery, or an accumulator. However, this is not the case in most sensors used in the industrial sector. Rather, the sensor is supplied with electrical energy by a peripheral unit via the first connecting means. In order that the sensor can be supplied with electrical energy in the configuring mode also, the sensor can be advantageously supplied with electrical energy via the second connecting means when the sensor is connected to an external computer.

In principle, the first and second connecting means can be separate physical units.

However, in a particularly preferred embodiment of the sensor of the invention, the first connecting means and the second connecting means are formed by one and the same connection, more particularly by one and the same plug-type connector. In such a case, advantageously no modifications have to be made to the housing and the peripheral connections of the sensor.

It is particularly preferred to use round plug-type connectors having a sealing effect as the plug-type connectors for sensors used in automation technology. These can include, for example, 4- or 5-pin plug-type connectors, particularly V1 or V3 plug-type connectors.

The configuring mode always involves a configuration procedure that can be optionally carried out during the measuring operation. The configuring mode and the operating mode can thus overlap in time, that is, they can be carried out simultaneously.

In order to make it possible to carry out the correct adjustments within the sensor and to switch the sensor to a configuring or measuring mode, it is advantageous when an electronic system is present that detects whether the sensor operatively communicates with a peripheral unit and/or whether the sensor is connected to an external computer. Such an electronic system can also reduce the risk of damage due to an excessively high voltage level at the contacts of the plug-type connectors that form the connecting means. Furthermore, in special situations in which the sensor is connected both to a peripheral unit and to an external computer, conflicts can be prevented, for example, between the peripheral unit and the external computer.

For this purpose, in a simple variant, the electronic system can analyze a supply voltage applied to at least one contact of the first or second connecting means. Additionally or alternatively, the electronic system can analyze a data signal present at a contact of the first or second connecting means. In principle, data signals present at a number of contacts of the first or second connecting means can be analyzed. On the whole, it is possible to determine in a reliable manner as to whether the sensor is operatively connected or whether the sensor is connected to an external computer.

Furthermore, the memory of the control/evaluation unit preferably comprises a read-only area. For example, a user manual can be stored therein which can be opened and viewed on the external computer when the sensor is connected to the latter. Such a user manual can be updated or amended in that new versions can be downloaded to the external computer via the Internet and then transferred to the sensor.

If the storage capacity of the microcontroller used is not sufficient, additional memory modules can be used, if necessary.

Advantageously, a boot loader capable of effecting subsequent programming of the microcontroller is present or stored in the memory of the control/evaluation unit.

In a further preferred variant of the sensor of the invention and of the method of the invention, the control/evaluation unit is adapted to transfer configuration data differentially between the sensor and the computer, in the configuring mode, via two wires of a data line. This achieves greater interference immunity and thus a faster transfer speed.

Very preferably, conventional standard protocols are implemented for the configuring mode and the data are then transferred between the sensor and the external computer at a bandwidth of more than 1 MBit/s. A further advantage in this case is that no additional development work is required.

Theoretically, the data transfer between the sensor and the computer can be achieved using a conventional serial interface, such as RS-232.

Very preferably, the sensor is connected to a USB interface of the external computer for the configuring mode. The sensor is then recognized and treated, for example, as a mass storage device by the external computer. Also, the supply of electrical energy via the USB interface is possible. The control/evaluation unit then has a corresponding USB functionality, the external computer acting as the USB host and the sensor as the USB slave.

Configuration of the sensor or reinstallation of, or supplementation of, the firmware of the sensor is very conveniently and easily carried out when the configuring software program is automatically started on the external computer once the sensor has been connected to the external computer.

If the settings on the external computer do not allow for a fully automatic start of the configuring software program, provision may be preferably made for only minimum user interaction to be required for starting the configuring software program, for example merely by means of a single confirmation by the user by pressing the ENTER key.

The respective up-to-date versions of the firmware or configuring software program for the sensors can be stored on a server that can be accessed via the Internet. It is therefore particularly advantageous when the configuring software program stored on the sensor prompts the external computer to establish a network connection to a remote host and to check whether new program versions of the configuring software program and/or sensor firmware are available and optionally to download such up-to-date program versions from the remote host and transfer the same to the memory of the sensor.

The configuring software program can basically be stored on the sensor in the form of executable code. In order to achieve greater independence from the external computer actually used, the configuring software program can be one which is very preferably capable of being executed platform-independently. For example, the configuring software program can be stored as interpretable code.

Additional features and advantages of the invention are described below with reference to the attached diagrammatic drawing, in which:

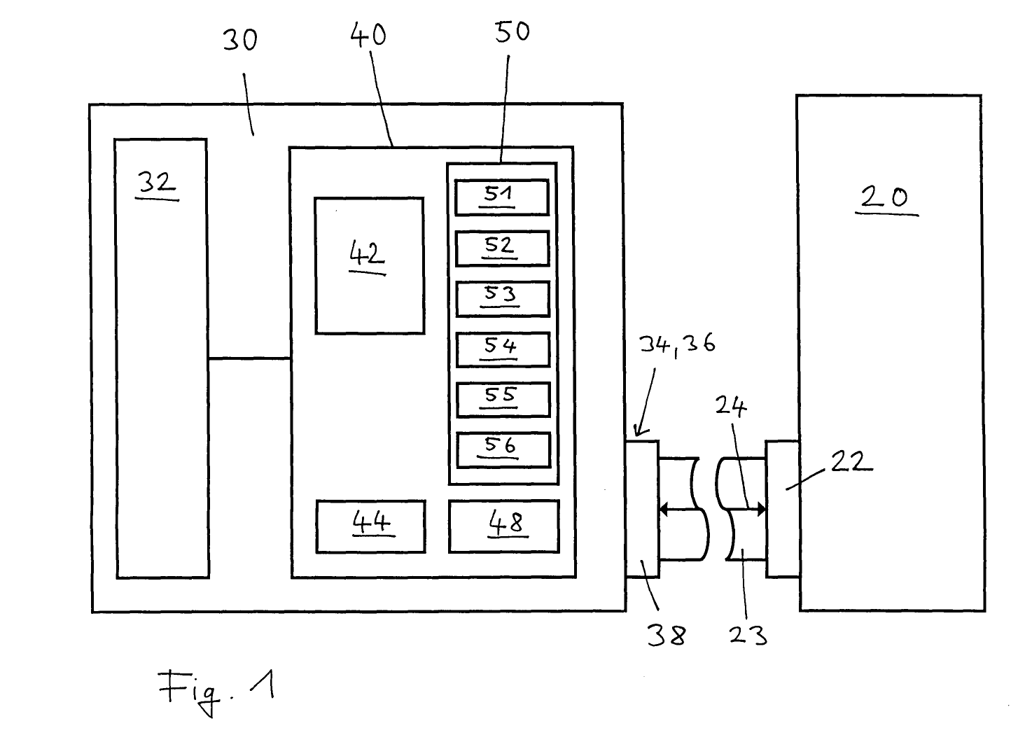

FIG. 1 is a diagrammatic view of an exemplary embodiment of a sensor of the invention.

The essential components of the sensor 30 shown diagrammatically in FIG. 1 are a sensor element 32, for example, a coil, a control/evaluation unit 40 comprising a memory 50, and a plug-type connector 38, by means of which both a first connecting means 34 and a second connecting means 36 are formed.

In the operating mode, the sensor 30 is connected to a peripheral unit (not shown), for example a programmable logic control unit, via the plug-type connector 38.

In the situation shown in FIG. 1, the sensor 30 is in a configuring mode and is connected via a USB cable 23 to a USB interface 22 of a computer 20, more particularly a PC. The double arrow 24 indicates that data exchange can occur in both directions.

The control/evaluation unit 40 is a microcontroller having a flash memory as the memory 50. Currently, such microcontrollers having a flash memory are available which have a storage capacity of from 512 KB to 1 MB. Apart from storing the sensor firmware 52 and permanently stored data such as calibration data 54 and a parameter file 55, this large memory 50 provides sufficient space for storing an independent configuring software program 56 which is intended, according to the invention, to permit convenient configuration and parameter-setting of the sensor 30.

Furthermore, the memory 50 comprises a read-only area 51, in which, for example, a user manual for the sensor can be stored that can be viewed by a user on a monitor of this computer when the sensor 30 is connected to the computer 20. Furthermore, a software program 53, a so-called boot loader, which enables subsequent programming of the microcontroller, is provided in the memory 50.

As additional components, the control/evaluation unit 40 comprises a CPU 42 and an electronic system 48 that checks whether the sensor 30 operatively communicates with a peripheral unit or whether the sensor 30 is connected to an external computer 20, as in the situation illustrated. This electronic system 48 is not a demodulation circuit, since, in the present invention, the supply voltage and the data are fed through separate contacts of the plug-type connector 38. A USB operation can, for example, be determined by the use of a sensor operating voltage of 5 volts, which is far from the voltage range of from 10 to 30 volts DC that is customary for sensors used in automation technology. Accordingly, the electronic system 48 can cause the sensor to return to normal operation when the operating voltage is in the aforementioned range of from 10 to 30 volts and the sensor is accordingly connected to a peripheral unit. The supply voltages need not be applied to the same contacts of the plug-type connector 38, but instead it is basically possible for the supply voltage to be each applied to different pins.

When the sensor 30 is connected to the USB interface 22 of the computer 20, a USB interface 44 within the sensor 30 is then accessed, by means of which USB slave functionality is achieved.

The sensor 30 can then act as a mass storage device and is handled by the PC accordingly. For example, the data can be stored in a file system in the memory 50. Such a file system can be recognized automatically by the operating system once the sensor 30 has been plugged into the interface 22 of the computer 20. Following the plug-in, the computer 20 can then access the files in the mass storage device in the usual manner.

One of these files contains the configuring software program 56 which provides an easily operable graphical user interface and which is started on the computer 20 either automatically or optionally following user confirmation, i.e. with minimum user interaction, after the sensor 30 has been plugged into the computer 20. With the aid of this configuring software program 56, the sensor 30 can be interactively configured by a user and, for example, modifications can be made to the parameter file 55 and/or to the calibration data 54. The configuring software program 56 can be implemented, for example, in Java, in which case the computer 20 can run this program without any difficulty. Modifications and adjustments made by the user with the aid of the configuring software program 56 during the configuration phase can be stored permanently in, for example, an additional file in the memory 50 of the sensor 30. Access to this file is then possible with the aid of the sensor firmware 52 via a suitable interface during normal operation of the sensor, that is, when the sensor is connected to the peripheral unit.

The present invention provides a novel sensor and method for configuring a sensor, in which a conventional round plug-type connector with a sealing effect is used, in particular, as an alternative means of communication with an external computer via a USB protocol. According to the invention, the sensor includes, in particular a graphical, parameterization tool or configuring software program which can be employed during manufacture of the sensor, but can also be used by the end user for configuration purposes. Due to the invention, firmware updates and updates of the configuring software program can be effected simultaneously and can also be carried out very conveniently, for example, by the end user himself, if necessary.

Theoretically, it is possible to provide an additional plug-type connector on the sensor housing to achieve the USB connection to the external computer. Other interfaces or protocols such as Firewire can likewise be used. Very preferably, USB protocols and developments or variants thereof are used. Finally, a wireless interface to the external computer is theoretically possible

1-18. (canceled)

19. A sensor for use in automation technology for identification of a measurand, comprising:
a sensor element for measuring a physical variable;
a first connecting means for connecting the sensor to a peripheral unit in an operating mode; and
a control/evaluation unit for controlling the sensor element, for processing a measured signal from the sensor element and for outputting an output signal to the first connecting means, which control/evaluation unit has a memory for the storage of at least configuration data and program data of the sensor;
wherein
a second connecting means is present for connecting the sensor to an external computer for a configuring mode;
in the memory of the control/evaluation unit there is stored configuring software, which can be uploaded into a RAM of an external computer when the sensor is connected to the external computer; and
the configuring software is adapted for automatic configuration of the sensor or interactive configuration thereof by a user.

20. The sensor as defined in claim 19,
wherein
the first connecting means and the second connecting means are formed by one and the same connection.

21. The sensor as defined in claim 19,
wherein
the first connecting means and the second connecting means are formed by one and the same plug-type connector.

22. The sensor as defined in claim 19,
wherein
the sensor is supplied with electrical energy via the first connecting means when the sensor is connected to a peripheral unit.

23. The sensor as defined in claim 19,
wherein
the sensor is supplied with electrical energy via the second connecting means when the sensor is connected to an external computer.

24. The sensor as defined in claim 19,
wherein
the sensor is supplied with electrical energy via the first connecting means when the sensor is connected to a peripheral unit; and
the sensor is supplied with electrical energy via the second connecting means when the sensor is connected to an external computer.

25. The sensor as defined in claim 19,
wherein
an electronic system is present which detects at least one of whether the sensor operatively communicates with a peripheral unit and whether the sensor is connected to an external computer.

26. The sensor as defined in claim 25,
wherein
the electronic system analyzes a supply voltage applied to at least one contact of the first connecting means or the second connecting means.

27. The sensor as defined in claim 25,
wherein
the electronic system analyzes a data signal present at at least one contact of the first connecting means or of the second connecting means.

28. The sensor as defined in claim 19,
wherein
the control/evaluation unit is adapted to transfer, in the configuring mode, configuration data differentially between the sensor and the computer via two wires of a data line.

29. The sensor as defined in claim 19,
wherein
the memory of the control/evaluation unit has a read-only area.

30. The sensor as defined in claim 21,
wherein
the plug-type connector is a round plug-type connecter having a sealing effect.

31. The sensor as defined in claim 19,
wherein
a boot loader is present in a memory of the control/evaluation unit.

32. The sensor as defined in claim 19, which is configured for detection of objects or articles,
wherein the sensor is temporarily connected to the external computer;
wherein the configuring software stored in the memory of the sensor is then uploaded into the RAM of the computer; and
wherein the sensor is then configured with the aid of the configuring software automatically or by a user.

33. A method for configuring a sensor for use in automation technology,
wherein the sensor is temporarily connected to an external computer;
wherein configuring software stored in a memory of the sensor is then uploaded into a RAM of the computer; and
wherein, in a configuring mode, the sensor is then configured with the aid of the configuring software automatically or by a user.

34. The method as defined in claim 33,
wherein,
in the configuring mode, configuration data are transferred differentially between the sensor and the computer via two wires of a data line.

35. The method as defined in claim 33,
wherein
a bandwidth with which data are transferred in the configuring mode between the sensor and the external computer is greater than 1 MBit/s.

36. The method as defined in claim 33,
wherein
the sensor is recognized and treated by the external computer as a mass memory.

37. The method as defined in claim 33,
wherein
the sensor is connected, in the configuring mode, to a USB interface of the external computer.

38. The method as defined in claim 33,
wherein
after the sensor has been connected to the external computer, the configuring software is started on the external computer automatically or following confirmation by a user.

39. The method as defined in claim 33,
wherein
the configuring software prompts the external computer to establish a network connection to a remote-host and to check whether new program versions for the configuring software and/or new sensor firmware are available and that any up-to-date program versions are downloaded from the remote-host and transferred to the memory of the sensor.

40. The method as defined in claim 33,
wherein
the configuring software is stored in the memory of the sensor as an executable or interpretable program.

41. The method as defined in claim 33,
wherein the sensor comprises:
a sensor element for measuring a physical variable;
a first connecting means for connecting the sensor to a peripheral unit in an operating mode; and
a control/evaluation unit for controlling the sensor element, for processing a measured signal from the sensor element and for outputting an output signal to the first connecting means, which control/evaluation unit has a memory for the storage of at least configuration data and program data of the sensor;
wherein
a second connecting means is present for connecting the sensor to the external computer for a configuring mode;
in the memory of the control/evaluation unit there is stored configuring software, which can be uploaded into the RAM of the external computer when the sensor is connected to the external computer; and
the configuring software is adapted for automatic configuration of the sensor or interactive configuration thereof by a user.
